(19) United States
(12) Patent Application Publication
(10) Pub. No.: US 2010/0281061 A1
(43) Pub. Date: Nov. 4, 2010

(54) Semantic Data Validation of Disjoint Data

(75) Inventor: Jiayue Chen, Austin, TX (US)

Correspondence Address: IBM Corp. (GIG), c/o Garg Law Firm, PLLC, 4521 Copper Mountain Lane, Richardson, TX, 75082, US

(73) Assignee: International Business Machines Corporation, Armonk, NY (US)

(21) Appl. No.: 12/432,916

(22) Filed: Apr. 30, 2009

(51) Int. Cl. G06F 17/30

(52) U.S. Cl. 707/794; 707/E17.045

(57) ABSTRACT

A method, system, and computer usable program product for semantic data validation of disjoint data are provided in the illustrative embodiments.

A mapping is performed for artifacts from a schema to artifacts in a selected ontology, creating a mapping graph having nodes. A first node in the nodes is analyzed using an inference algorithm. The analyzing determines a semantic error in a data corresponding to the schema artifact represented at a second node. A correction for the data is provided such that the correction eliminates the semantic error. Selecting the ontology includes receiving a set of ontologies from ontology sources. A subset of ontologies may be aggregated from the set of ontologies to form a super-ontology. A set of schema artifacts may be matched to a set of artifacts of the super-ontology. The super-ontology may be reduced to form a reduced ontology. The reduced ontology forms the ontology.

### BACKGROUND OF THE INVENTION

1. Field of the Invention

The present invention relates generally to an improved data processing system, and in particular, to a computer implemented method for managing data for data consistency. Still more particularly, the present invention relates to a computer implemented method, system, and computer usable program code for semantic data validation of disjoint data.

2. Description of the Related Art

Data processing environments often include data that may distributed across several data processing systems. Portions of data, or data components, may exist on separate data processing systems and may be brought together, correlated, or integrated by particular systems for particular purposes.

For example, enterprise systems are software applications that often have modules, or software components, executing on separate data processing systems. Associated with a software component may be a data component that is usable with that software component. That data component may have counterpart data components that may be similarly used by other software components.

As another example, a data processing environment may have several software applications executing thereon, each associating with a data source, such as a database or another data repository. Information stored in different data sources, data components stored in one or more data source, and different bodies of data, unless identical to one another, form disjoint data. In other words, disjoint data is a collection of data, portions of which are distinct from one another.

A data source may contain information that may be different from the information in another data source but pertaining to a common subject. The contents of the two data sources may also be classified as disjoint data. For example, one database in an organization may have one set of employee records for pension accounts and another set of employee records for performance measurements. The two sets of employee records are likely to contain different information about the same employee in some instances.

Disjoint data may contain inaccuracies. For example, the name of an employee may be spelled with only the initial for the middle name in one data source and with full middle name in another. As another example, two data sources containing employee records may contain different start date of the employee's employment.

Present data manipulation tools include capabilities that can detect syntax errors and statistical errors, such as the errors in the examples above. Data extraction transformation and loading tools (ETL tools) are a type of data manipulation tool. An ETL tool includes components to communicate with one or more data source, extract data from those data sources, transform or structurally modify that data into a form acceptable to a data consumer, and provide or load the data into the data consumer.

A syntax error, or a syntactical error, is an error in syntax or structure of the data. The middle initial and middle name discrepancy is an example of syntax error. A statistical error is a computational or compilation error based on the data itself. A computed account balance of a financial account in a data source that is incorrect based on a given data of deposit and withdrawal transactions from the same or different data source is a statistical error.

### SUMMARY OF THE INVENTION

The illustrative embodiments provide a method, system, and computer usable program product for semantic data validation of disjoint data stored in a computer memory. An ontology stored in an ontology source in a computer memory is selected. A mapping is performed for artifacts from a schema representing the stored disjoint data to artifacts in the ontology, the artifacts from the schema forming schema artifacts, and the artifacts from the ontology forming ontology artifacts. Performing the mapping operation creates a mapping graph having nodes. A node represents the correspondence of a schema artifact to an ontology artifact. A first node in the nodes is analyzed using an inference algorithm in a processor of a computer. The analyzing determines a semantic error in a data corresponding to the schema artifact represented at a second node. A correction for the data is provided to a data storage unit in a data processing system, a display in a data processing system, or a combination thereof, such that the correction eliminates the semantic error.

In one embodiment, selecting the ontology further includes receiving a set of ontologies from one or more ontology source. The embodiment may aggregate a subset of ontologies from the set of ontologies to form a super-ontology. A set of schema artifacts may be matched to a set of artifacts of the super-ontology. The super-ontology may be reduced to form a reduced ontology by making unavailable a subset of artifacts from the set of artifacts of the super-ontology such that an artifact in the subset of artifacts either does not have a corresponding artifact in the schema artifacts, or matches with a corresponding artifact in the schema artifacts below a threshold degree of match, or both. The reduced ontology is presented as the ontology.

In another embodiment, the making unavailable a subset of artifacts may leave a second subset of artifacts available for use in the super-ontology. In the embodiment reducing the super-ontology may further include selecting a subset of ontologies from the set of ontologies such that ontologies in subset of ontologies together include all members of the second subset of artifacts of the super-ontology. The ontologies in the subset of ontologies may be combined to form a combined ontology, the combined ontology becoming the reduced ontology.

In another embodiment, selecting the ontology may further include receiving a set of ontologies from one or more ontology source. A first ontology may be chosen from the set of ontologies. As a first matching, a set of schema artifacts may be matched to a set of artifacts of the first ontology. A first match description may be generated describing a characteristic of match from the first matching. A second ontology may be chosen from the set of ontologies. As a second matching, the set of schema artifacts may be matched to a set of artifacts of the second ontology. A second match description may be generated describing a characteristic of match from the second matching. A selection may be performed from the first and the second ontology using the first and second match descriptions, the selecting yielding the ontology.

In another embodiment, the first and second match descriptions may each be a degree of match. The second selecting may further include combining the first and the second ontologies, the combining yielding a combined ontology. The combined ontology may be presented as the ontology.

In another embodiment, performing the mapping may further include using a forward inference from a schema artifact in the schema artifacts to map the schema artifact to an ontology artifact in the ontology artifacts. In one embodiment, the forward inference may be an operation of a second inference algorithm. The second inference algorithm may be same as the inference algorithm, or different from the inference algorithm.

In another embodiment, the schema may be a federated data schema generated by combining several schemas associated with a set of disjoint data from several data sources. In the embodiment, the analyzing may further include validating the data represented at the second node in reference to the data represented at a third node. The validating may cause a rule from several rules to execute. A determination may be made from the validating that the semantic error exists between the data represented at the second node in reference to data represented at a third node. A conclusion may be determined that the data represented at the second node is to be corrected.

In another embodiment, the concluding may further include executing a second rule from several rules. The output of executing the second rule may cause the determination of the conclusion. In one embodiment, the second rule may be a data ownership rule. In another embodiment the second rule may be a majority rule. In another embodiment the second rule may be a trustworthiness rule. In another embodiment the second rule may be a combination of the data ownership rule, the majority rule, and the trustworthiness rule.

In another embodiment, providing the correction may further include applying the correction to the data represented at the second node by correcting the data at a source of the data; publishing a report, the report including a recommendation for correcting the data represented at the second node; or a combination thereof. In one embodiment, providing the correction may further include detecting a condition in a data processing environment, causing an action in the data processing environment, determining a value of a second data, or a combination thereof.

### BRIEF DESCRIPTION OF THE DRAWINGS

The novel features believed characteristic of the invention are set forth in the appended claims. The invention itself; however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which illustrative embodiments may be implemented;

FIG. 2 depicts a block diagram of a data processing system in which illustrative embodiments may be implemented;

FIG. 3 depicts a block diagram of an example semantic data validation that may be performed by using an illustrative embodiment;

FIG. 4 depicts a block diagram of a configuration of a semantic data validation application in accordance with an illustrative embodiment;

FIG. 5 depicts a block diagram of a configuration of a semantic data validation application in accordance with an illustrative embodiment;

FIG. 6 depicts a block diagram of some components of a semantic data validation application in accordance with an illustrative embodiment;

FIG. 7 depicts a block diagram of some components of a semantic data validation engine in accordance with an illustrative embodiment;

FIG. 8 depicts a block diagram of some components of an ontology selector in accordance with an illustrative embodiment;

FIG. 9 depicts a block diagram of some additional components of a semantic data validation application in accordance with an illustrative embodiment;

FIG. 10 depicts a block diagram of some example operations that may be configured to execute using a user interface component of a semantic data validation application in accordance with an illustrative embodiment;

FIG. 11 depicts a block diagram of some example operations that may be configured to execute using an application interface component of a semantic data validation application in accordance with an illustrative embodiment;

FIG. 12 depicts a flowchart of a process of performing semantic data validation in accordance with an illustrative embodiment;

FIG. 13 depicts a flowchart of a process of providing a federated data schema in accordance with an illustrative embodiment;

FIG. 14 depicts a flowchart of a process of selecting an ontology in accordance with an illustrative embodiment;

FIG. 15 depicts a flowchart of a process of semantic data validation in accordance with an illustrative embodiment; and

FIG. 16 depicts a flowchart of a process of detecting a semantic error in accordance with an illustrative embodiment.

### DETAILED DESCRIPTION OF THE PREFERRED EMBODIMENT

The invention recognizes that presently available data manipulation tools are limited in the types of errors and inconsistencies they can discover and correct in disjoint data. For example, the presently available ETL tools can only detect, and sometimes remedy, syntactical and statistical errors, and other data inconsistencies readily discoverable by comparing two versions of the same data.

The invention further recognizes that data, including disjoint data can include logical inconsistencies that are not readily discerned simply by comparing two versions of the same data or recomputing using the same data. Such logical inconsistencies are called semantic errors or semantic inconsistencies, and are often revealed by logically relating various pieces of information from one or more data sources together.

The illustrative embodiments used to describe the invention address and solve the problem related to semantic inconsistencies in data. The illustrative embodiments provide a method, computer usable program product, and data processing system for semantic data validation over disjoint data. Using the illustrative embodiments, a system or an application can validate disjoint from a logical consistency point of view, and discover any logical inconsistencies that may exist in the disjoint data. In some embodiments, the semantic data validation is extended to include correcting or providing a recommendation for correction of the semantically inaccurate data.

The illustrative embodiments use, among other things, inference algorithms and knowledge ontologies to perform the semantic data validation. An inference algorithm is an algorithm or computer usable code encoding process steps to traverse a graph representing given data and draw inferences from the data at the traversed points in the graph. A hierarchical construct representing the structure of data is one example of such a graph.

For example, a graph may represent information relating to a person. A “person” node may have a “name” and “role” nodes there under. The “role” node may have “family” and “business” nodes there under, and so on, forming an inverted tree-like graph that represents personal data. As another example, a “seller” node may have “location” and “products” nodes there under. The “products” node may have “product name”, “manufacturer”, and “product version” nodes there under. The “product version” node may have “restrictions”, “compatibility”, “pre-requisites” nodes there under, and so on, as may be suitable for a particular configuration of data.

A knowledge ontology, or simply an ontology, is a model of knowledge that exists about a domain with which the knowledge about the domain can be described. An ontology defines a set of representational primitives with which to model a domain of knowledge or discourse. The representational primitives are typically classes or sets, attributes or properties, and relationships or relations among class members. The definitions of the representational primitives include information about their meaning and constraints on their logically consistent application. For example, in the context of database systems, ontology can be viewed as a level of abstraction of data models, analogous to hierarchical and relational models, but intended for modeling knowledge about individuals, their attributes, and their relationships to other individuals. Ontologies are typically specified in languages that allow abstraction away from data structures and implementation strategies. In practice, the languages of ontologies are closer in expressive power to first-order logic than languages used to model databases or systems. For this reason, ontologies are said to be at the “semantic” level.

The examples in this disclosure are used only for the clarity of the description and are not limiting on the illustrative embodiments. Additional operations, actions, tasks, activities, and manipulations will be conceivable from this disclosure and the same are contemplated within the scope of the illustrative embodiments.

The illustrative embodiments are described using specific code, data structures, designs, layouts, schematics, and tools only as examples and are not limiting on the illustrative embodiments. The illustrative embodiments may be implemented with respect to any type of data or data source. For example, a directory entry may contain information about a user, a system, or an application, and the entry may be compared to a disjoint data record in a relational database containing information that may or may not relate to the user, the system, or the application of the directory entry.

Furthermore, the illustrative embodiments are described in some instances using particular software tools and data processing environments only as an example for the clarity of the description. The illustrative embodiments may be used in conjunction with other comparable or similarly purposed systems, applications, or architectures. For example, some illustrative embodiments that are described in conjunction with ETL tools can be used in conjunction with any data manipulation tool suitable for the particular purpose within the scope of the illustrative embodiment.

Any advantages listed herein are only examples and are not intended to be limiting on the illustrative embodiments. Additional or different advantages may be realized by specific illustrative embodiments. Furthermore, a particular illustrative embodiment may have some, all, or none of the advantages listed above.

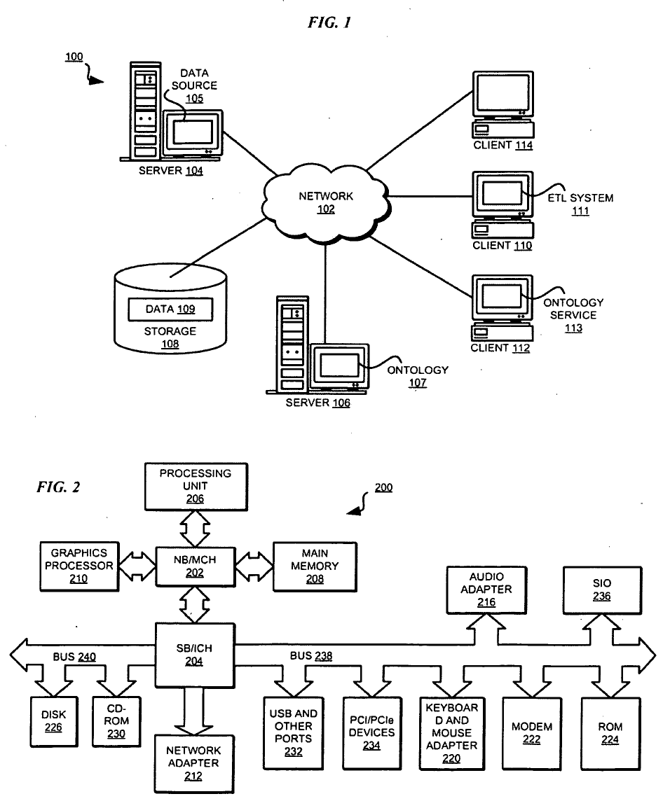

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a pictorial representation of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables. Server 104 and server 106 couple to network 102 along with storage unit 108. Software applications may execute on any computer in data processing environment 100.

In addition, clients 110, 112, and 114 couple to network 102. A data processing system, such as server 104 or 106, or client 110, 112, or 114 may contain data and may have software applications or software tools executing thereon. For example, server 104 may include data source 105. Server 106 may provide an ontology service and serve ontology 107. Storage unit 108 may include data 109. Client 110 may include ETL tool, such as ETL system 111. Client 112 may also serve one or more ontologies by having ontology service 113 executing thereon.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client server environment in which the illustrative embodiments may be implemented. A client server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as server 104 or client 110 in FIG. 1, in which computer usable program code or instructions implementing the processes may be located for the illustrative embodiments.

In the depicted example, data processing system 200 employs a hub architecture including North Bridge and memory controller hub (NB/MCH) 202 and south bridge and input/output (I/O) controller hub (SB/ICH) 204. Processing unit 206, main memory 208, and graphics processor 210 are coupled to north bridge and memory controller hub (NB/MCH) 202. Processing unit 206 may contain one or more processors and may be implemented using one or more heterogeneous processor systems. Graphics processor 210 may be coupled to the NB/MCH through an accelerated graphics port (AGP) in certain implementations.

In the depicted example, local area network (LAN) adapter 212 is coupled to south bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to south bridge and I/O controller hub 204 through bus 238. Hard disk drive (HDD) 226 and CD-ROM 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to south bridge and I/O controller hub (SB/ICH) 204.

An operating system runs on processing unit 206. The operating system coordinates and provides control of various components within data processing system 200 in FIG. 2. The operating system may be a commercially available operating system such as Microsoft® Windows® (Microsoft and Windows are trademarks of Microsoft Corporation in the United States and other countries), or Linux® (Linux is a trademark of Linus Torvalds in the United States and other countries). An object oriented programming system, such as the Java™ programming system, may run in conjunction with the operating system and provides calls to the operating system from Java™ programs or applications executing on data processing system 200 (Java is a trademark of Sun Microsystems, Inc., in the United States and other countries).

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory, such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in north bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a PDA.

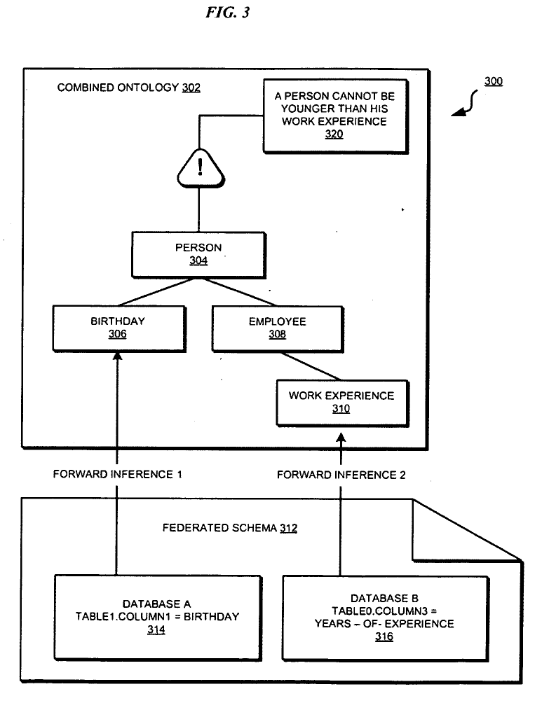

With reference to FIG. 3, this figure depicts a block diagram of an example semantic data validation that may be performed by using an illustrative embodiment. Validation 300 may be implemented, as an example, in a software application, that may execute on a data processing system, such as any of servers 104 and 106, or any of clients 110, 112, and 114, or a combination thereof, in FIG. 1.

Combined ontology 302 is an ontology that results from combining one or more other ontologies. In one embodiment, combined ontology 302 may simply be an existing ontology. In another embodiment, combined ontology 302 may be a combination of some portions of two or more ontologies. In the example depicted in this figure, combined ontology 302 results from combining an ontology that may describe a human being as a person with another ontology that may describe business organizations that may include employees.

According to example combined ontology 302, person 304 may be a human being who may also be an employee. Accordingly, person 304 may have birthday 306 and characteristics of employee 308. Employee 310, as one of the characteristics, may have work experience 310. Combined ontology 302 may have other nodes that are not shown in this figure for clarity.

Federated schema 312 may be a data schema that results from combining one or more other schema. In one embodiment, federated schema 312 may simply be an existing schema. In another embodiment, federated schema 312 may be a combination of some portions of two or more schemas. In the example depicted in this figure, federated schema 312 results from combining a schema of data that may describe a human being as a person with another schema of another data that may describe business organizations that may include employees.

As an example, a database called “database A” may store information about persons in one or more tables with one or more columns. A column, “column1,” in a table, “table1,” may store birthdays of persons represented in “database A”. Artifact 314 of federated schema 312 represents column1 of table1 of database A part of a schema of the first database.

Similarly, a database called “database B” may store information about a business organization in one or more tables with one or more columns. A column, “column3,” in a table, “table0,” may store years-of-experience of employees represented in “database B”. Federated schema 312 may combine, among other parts of the two schemas, column1 of table1 of database A, and column3 of table0 of database B. Artifact 316 of federated schema 312 represents column3 of table0 of database B part of a schema of the second database.

Semantic validation of the data about persons may be performed using combined ontology 302 and federated schema 312 using forward inferences according to the illustrative embodiments. A forward inference is logic that uses certain data as a premise and creates a conclusion based on that premise. A forward inference according to the illustrative embodiments can use any number of premise data and can create one or more conclusions. A forward inference according to the illustrative embodiments can be implemented into code that can be executed in a software application on a data processing system. Drawing inferences, including forward inferences, may be an operation of an inference algorithm.

In the depicted example in FIG. 3, artifact 314 forms the premise that corresponds to a conclusion that artifact 314 represents a person's birthday, and can be used as birthday 306 in combined ontology 302. Similarly, artifact 316 forms the premise that corresponds to a conclusion that artifact 316 represents a person's work experience, and can be used as work experience 310 in combined ontology 302.

An application can implement semantic data validation of the disjoint data by configuring personal and business data in the manner of FIG. 3. The semantic validation according to an embodiment of the invention may draw conclusion 320 that a person cannot be younger than the person's work experience. Thus, in this example, semantic validation of disjoint personal and business data can lead to a correction either the person's birthday or the person's years-of-experience, or both, which would otherwise not be possible by presently available statistical or syntactical methods.

Some more examples of semantic validation of disjoint data according to the illustrative embodiments are provided. A first database with a first schema may contain data about vendors with whom an organization does business. A second database with a second schema may contain data about the various products the organization uses. Based on a combined ontology created for determining taxation, a consumer may be able to determine what makes an item taxable and how much tax is due under certain conditions. By using inferences of the location of the vendor and the location of the use of certain products, and by using the ontology for taxation, the organization can semantically validate the product data and determine if use tax is owed or has been paid for a particular product. In this example, the semantic validation may correct an incorrect tax amount that may have been paid, or determine the amount of tax that should be paid.

As another example, a database may contain authorization information for various users for accessing various resources in a data processing environment. Another database may describe workflows that execute in the data processing environment and utilize certain services, which in turn use certain resources. An authorization ontology may model how users are authorized for performing tasks in the data processing environment. Another ontology may model how exceptions are to be allowed in the data processing environment.

The two database schemas can be combined and the two ontologies can be combined in a suitable manner. Certain inferences from the combined schema can be used into the combined ontology to detect an authorization conflict when a certain user, such as an application that may not have permission to access a certain resource, attempts to communicate with a workflow, which utilizes that resource. In this example, the semantic validation according to the illustrative embodiments may detect a condition in an environment instead of or in addition to correcting data.

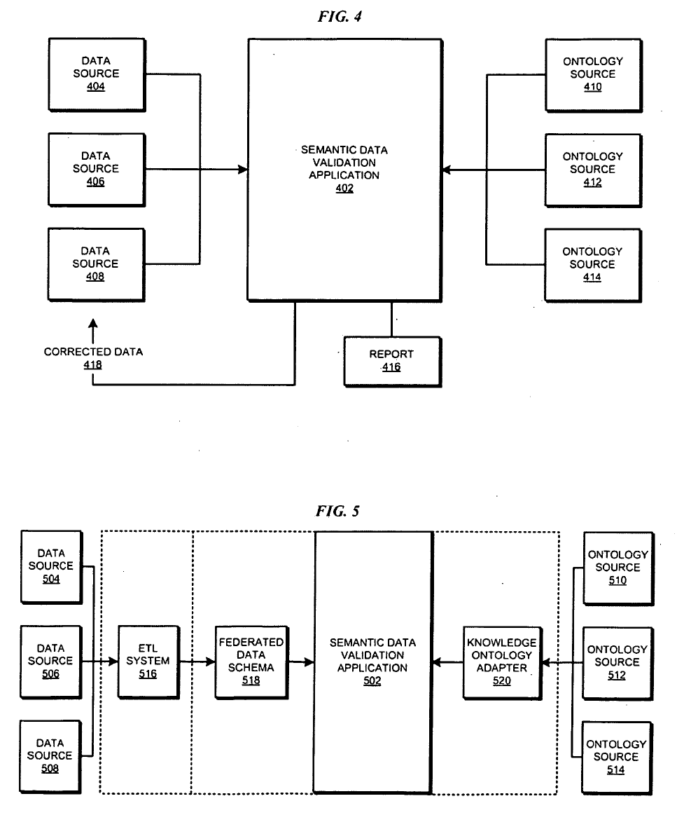

With reference to FIG. 4, this figure depicts a block diagram of a configuration of a semantic data validation application in accordance with an illustrative embodiment. Semantic data validation application 402 may be a software application that may execute on a data processing system, such as any of servers 104 and 106, or any of clients 110, 112, and 114, or a combination thereof, in FIG. 1. Data sources 404, 406, and 408 may each be implemented using any of data source 105 or storage unit 108 in FIG. 1. Ontology sources 410, 412, and 414 may each be implemented using server 106 serving ontology 107 or ontology service 113 in FIG. 1.

Semantic data validation application 402 accepts data from one or more data sources, such as from data sources 404, 406, and 408. Semantic data validation application 402 may accept data from any number of data sources without limitation. Semantic data validation application 402 accepts ontologies from one or more ontology sources, such as from ontology sources 410, 412, and 414.

Semantic data validation application 402 performs semantic data validation using some combination of data from data sources 404, 406, and 408, and some combination of ontologies from ontology sources 410, 412, and 414. As one result of the semantic data validation, semantic data validation application 402 may produce report 416. Report 416 may include recommendations for correcting data, actions to take in a data processing environment, new information, modified information, logical conclusions, or a combination thereof.

As another result of the semantic data validation, semantic data validation application 402 may produce corrected data 418. In one embodiment, corrected data 418 may be supplied to any of data sources 404, 406, or 408, such that a corresponding data in one or more of those data sources is modified using corrected data 418. In another embodiment, corrected data 418 may be provided to an application separate from data sources 404, 406, and 408, the application determining a way of using corrected data 418. Of course, semantic data validation application 402 may produce a combination of report 416 and corrected data 418 for particular configurations of data sources and ontologies used in a particular implementation.

In another embodiment, semantic data validation application 402 may produce corrected data 418 by identifying data from a particular data source as being inconsistent with data from other data sources. In so identifying, semantic data validation application 402 may inherently or explicitly determine which data source to trust more as compared to other data sources. In other words, semantic data validation application 402 may utilize a trust ranking of data sources 404, 406, and 408 to determine data from which of those data sources to deem trustworthy, and therefore reliable, and data from which other of those data sources to deem unreliable, if inconsistent.

Semantic data validation application 402 may determine the trustworthiness of data sources in a variety of ways. For example, a data source in a federated data environment may have a certain degree of trustworthiness associated with that data source. Each data source in the federated data environment may have degrees of trustworthiness relative to one another, such that a data source in the federated data environment may be more trustworthy than another data source in the federated data environment.

For environments including a mix of data sources, another embodiment may employ rules to determine the trustworthiness of those data sources. Consequently, semantic data validation application 402 may execute a rule that may determine data from which data source may be inconsistent with data from other one or more data source and may have to be remedied.

Such rules may be configured in any manner suitable for a particular implementation of an embodiment of the invention. For example, a rule may give more weight to one data source over another based on the ownership of the data stored therein. In one embodiment of such an ownership type rule, a data source that is owned by the entity executing the semantic validation may be deemed to be more reliable than an external data source.

Accordingly, if either of the data in the owned data source or the data in the external data source could be corrected to remove the logical inconsistency, the correction of data in the external data source may be recommended. In another embodiment of the example rule, if the external data source is owned by a trusted organization, such as a certificate authority (CA), the rule may recommend correcting the data in the owned data source.

Another example rule may recommend using the data that has the same value across more data sources than the number of data sources that report a different value for the data. This type of a majority rule, the value of the data that has is the same across a majority of data sources may prevail over the value of the data that is different in other minority data sources.

Another example rule, some data sources may be deemed trustworthy and other data sources may not be trustworthy. According to such a trustworthiness rule, the data coming from a trustworthy data source may prevail over data coming from the other data sources.

The examples of data ownership rule, majority rule, and the trustworthiness rule are described only for the clarity of the description and are not limiting on the illustrative embodiments. Other rules for correcting data for semantic errors will be readily conceivable from this disclosure and the same are contemplated within the scope of the invention.

For example, an implementation may employ a combination of the trustworthiness rule and the ownership rule to determine that even if the data is from a foreign source, if that source is trustworthy, then that data can prevail over the data from an owned data source.

Once the trustworthiness of the various data sources involved in ascertained, inconsistent data can be identified based on which data source to trust when faced with conflicting or inconsistent data. One way of remedying the inconsistent data can be direct modification of the inconsistent data in the respective data source.

Another way of the remediation can be producing a report that describes the inconsistent data and its data source, and remediation steps to take with respect to that data source. A user, application, system, or a combination thereof can then implement the remediation steps. For example, a user can modify the inconsistent data in the data source through an interface to the data source.

With reference to FIG. 5, this figure depicts a block diagram of a configuration of a semantic data validation application in accordance with an illustrative embodiment. Semantic data validation application 502 may be analogous to semantic data validation application 402 in FIG. 4. Data sources 504, 506, and 508 may each be implemented in a manner similar to any of data sources 404, 406, and 408 in FIG. 4. Ontology sources 5.10, 512, and 514 may each be implemented using any of ontology sources 410, 412, and 414 in FIG. 4.

ETL system 516 may be implemented using ETL system 111 in FIG. 1. Furthermore, ETL system 516 may be a single ETL system communicating with several data sources, or multiple ETL systems each communicating with one or more data sources. Additionally, in one embodiment, ETL system 516 may be configured to be a part of semantic data validation application 502.

As one function according to the illustrative embodiments, ETL system 516 receives data schemas from one or more of data sources 504, 506, and 508. An application or a component thereof, in communication with ETL system 516, generates federated data schema 518. Federated data schema 518 serves as one input to semantic data validation application 502. In one embodiment of the invention, the application or component that generates federated data schema 518 may be a part of semantic data validation application 502.

Knowledge ontology adapter 520 may be an application or a component thereof that is configured to communicate with one or more ontology sources, such as ontology sources 510, 512, and 514. Furthermore, knowledge ontology adapter 520 may be a single knowledge ontology adapter communicating with several ontology sources, or multiple knowledge ontology adapters each communicating with one or more ontology sources. Additionally, in one embodiment, knowledge ontology adapter 520 may be configured to be a part of semantic data validation application 502.

As one function according to the illustrative embodiments, knowledge ontology adapter 520 receives ontologies from one or more of ontology sources 510, 512, and 514. Knowledge ontology adapter 520 provides the received ontologies as another input to semantic data validation application 502.

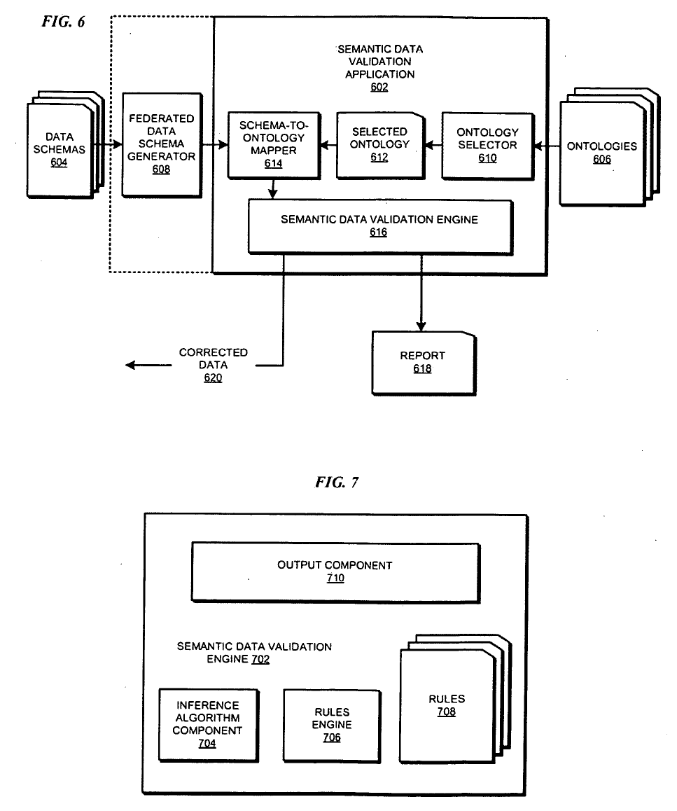

With reference to FIG. 6, this figure depicts a block diagram of some components of a semantic data validation application in accordance with an illustrative embodiment. Semantic data validation application 602 can be implemented as semantic data validation application 502 in FIG. 5. Data schemas 604 may be received from one or more data sources, such as any of data sources 504, 506, or 508 in FIG. 5. Ontologies 606 may be received from any of ontology sources 510, 512, or 514 in FIG. 5.

Federated schema generator 608 generates federated data schema using data schemas 604. Federated data schema generator 608 may be a part of semantic data validation application 602 or an application or component separate from and in communication with semantic data validation application 602.

Ontology selector 610 selects an ontology for use in semantic data validation process of semantic data validation application 602. In one embodiment, selecting an ontology may include simply selecting one of ontologies 606. In another embodiment, selecting an ontology may also include combining all or parts of two or more ontologies from ontologies 606, and selecting all or part of such a combination. Accordingly, selected ontology 612 may be an ontology from ontologies 606, or some combination of two or more ontologies from ontologies 606.

The federated data schema from federated data schema generator 608 and selected ontology 612 serve as inputs to schema-to-ontology mapper (mapper) 614. Mapper 614 uses forward inferences to combine portions of the federated data schema and selected ontology 612, and generates a mapping.

As an example, mapper 614 may link a column from the federated data schema to a concept in selected ontology 612, such as by using forward inferences. Mapper 614 may include criteria, rules, instructions, or logic to determine which column to select and relate to a given concept in selected ontology 612. In one embodiment, mapper 614 may use lexicographical matches between the names of a column and a concept to determine a mapping. In another embodiment, an inference algorithm may assist mapper 614 in making the mapping determination. In another embodiment, a configuration file or configuration instruction may inform mapper 614 about mapping a particular column to a particular concept.

These example ways of mapping a schema to an ontology are selected only for the clarity of the description and are not intended to be limiting on the illustrative embodiments. Many other ways of mapping parts of the federated data schema to parts of selected ontology 612 will be apparent from this disclosure and the same are contemplated within the scope of the invention.

Mapper 614 provides the mapping to semantic data validation engine 616. Semantic data validation engine 616 generates report 618, corrected data 620, or a combination thereof. Report 618 may be similar to report 416 in FIG. 4. Corrected data 620 may be similar to corrected data 418 in FIG. 4.

In one example configuration, semantic data validation application 602 may receive data in the form of a data stream that may constantly or periodically change. For example, once mapper 614 has generated a particular mapping and semantic data validation engine 616 can perform semantic validation of data corresponding to that mapping, this configuration of semantic data validation application 602 can then be used to detect and validate data from a data source as the data changes.

As an example, semantic data validation application 602 can be further configured to include a listener component (not shown) that listens to and receives a data stream. Any existing listener for data streams can be used for this purpose.

The data being communicated over the data stream may change at a point in time. The listener component would provide the changed data to semantic data validation application 602. Semantic data validation application 602, using the previously established configuration, can validate the changed data. By performing this validation, semantic data validation application 602 can determine if the changed data is consistent with other data from other data sources, of if the source of the data stream or another data source has to be remedied.

Furthermore, listener components can be configured to listen to an entire data stream or only certain aspects of the data within the data stream. For example, data about employees may be communicated as a data stream between databases in a data processing environment. A listener may monitor only the employment history aspect of data in a data stream. For example, the listener may monitor any change in employment duration, job roles, locations and any other selected aspect of employee related data.

Assume, for example, that a monitored aspect of the employee data, such as an employment duration for an employee, changes at a point in time, and the mapping loaded in semantic data validation engine 616 is configured to detect inconsistencies in employment data of the employees. The listener component may detect the changed employment duration for an employee and semantic data validation application 602, using the particular mapping and configuration of semantic data validation engine 616, may determine that the changed employment duration has caused an inconsistency to appear in the data. Additionally, semantic data validation application 602 may provide that the inconsistency is present in the source of the changed data or another data source.

The particular data stream, particular aspects of the data stream, and particular semantic validation thereof are only described as examples for the clarity of the operation of the invention. The particular descriptions are not limiting on the invention. Any other data streams and aspects of those data streams may be similarly utilized within the scope of the invention.

With reference to FIG. 7, this figure depicts a block diagram of some components of a semantic data validation engine in accordance with an illustrative embodiment. Semantic data validation engine 702 may be implemented as semantic data validation engine 616 in FIG. 6.

Semantic data validation engine 702 includes component 704 that implements one or more inference algorithms. Rules engine 706 executes a set of rules 708. A set of rules is one or more rules. A rule is an instruction implementing logic for manipulating data based on a condition. Output component 710 may generate reports, such as report 610 in FIG. 6, or corrected data, such as corrected data 620 in FIG. 6.

In operation, semantic data validation engine 702 uses inference algorithm component 704 to detect logical errors in data represented by federated data schema based on assertions defined in a selected ontology. Using the example described with respect to FIG. 3, semantic data validation engine 702 may initiate the two forward inference processes where specific columns of data from the federated data schema is mapped to specific concepts in the selected ontology. A rule in rules 708 may provide that if the two concepts—birthday and years-of-experience—are related, they should meet or converge at some concept in the ontology. In the example depicted in FIG. 3, the birthday concept and the work experience concept intersect at the concept of a person. In other words, a person can have both a birthday and a work experience.

Inference algorithm component 704 assists semantic data validation engine 702 in traversing the mapping to the intersection point from the two concept points in the graph of the mapping. At such an intersection point, another rule in rules 708 can assist semantic data validation engine 702 in validating the data associated with the two concepts of birthday and work experience. For example, a rule in rules 708 may include the logic that computes whether a work experience for a person is greater than the age of the same person. If during execution in rules engine 706 the rule computes to a “true” value, the logical anomaly is identified about the data representing the person. Semantic data validation engine 702 may then output an indication of that anomaly, output a correction to that anomaly, or recommend a correction for that anomaly, using output component 710.

With reference to FIG. 8, this figure depicts a block diagram of some components of an ontology selector in accordance with an illustrative embodiment. Ontology selector 802 may be used as ontology selector 610 in FIG. 6.

Ontology selector 802 may receive a set of ontologies 804. A set of ontologies is one or more ontologies. Aggregation component 806 may combine two or more ontologies from ontologies 804. Aggregation component 806 may use one or more rules from the set of rules 808 to determine how to combine ontologies. Ontology selector 802 may produce the combined ontology as selected ontology 810.

Optionally, aggregation component 806 may also reduce a combined ontology to create a selected ontology. The reduction may cause the selected ontology to be smaller in size than the combined ontology for increased efficiency in further use of the selected ontology. In one embodiment, aggregation component 806 may use rules 808 and match some concepts that may exist in the combined ontology with portions of a federated data schema. Using the matching, aggregation component 806 may trim, remove, or otherwise make unusable, portions of the combined ontology that do not match any portions of the federated data schema.

Matching component 812 may match or otherwise relate artifacts of a given federated data schema, to artifacts of one or more ontologies in ontologies 804. Matching component 812 may select an ontology form ontologies 804 that includes the highest number of artifacts that correspond with artifacts in the federated data schema. Matching component 812 produces such an ontology as selected ontology 810.

In one embodiment, matching component 812 may match artifacts based on lexicographic information provided by rules 808. For example, a rule may provide that “product name” artifact in an ontology can be matched to “title”, “product”, “product name”, a portion of “product version”, or other artifacts in a data schema.

Optionally, matching component 812 may also reduce an ontology that has the most number of artifacts corresponding with artifacts of a schema. In one embodiment, matching component 812 may trim, remove, or otherwise make unavailable those artifacts in such an ontology that fail to correspond with an artifact in the schema. In another embodiment, a degree of correspondence may be used to match artifacts of an ontology with artifacts of a schema. Matching component 812 may use a threshold value of such a degree to determine whether to remove a particular artifact of the ontology. Matching component 812 may produce the reduced ontology as selected ontology 810.

The example rules described in the operation of the components of ontology selector 802 are not limiting on the illustrative embodiments. Many rules for similar application will be conceivable from this disclosure and are contemplated within the scope of the illustrative embodiments. Furthermore, aggregation component 806 and matching component 812 may operate exclusively or in collaboration with respect to a particular implementation. For example, a particular implementation may use a combination of aggregation component 806 and matching component 812 to create selected ontology 810.

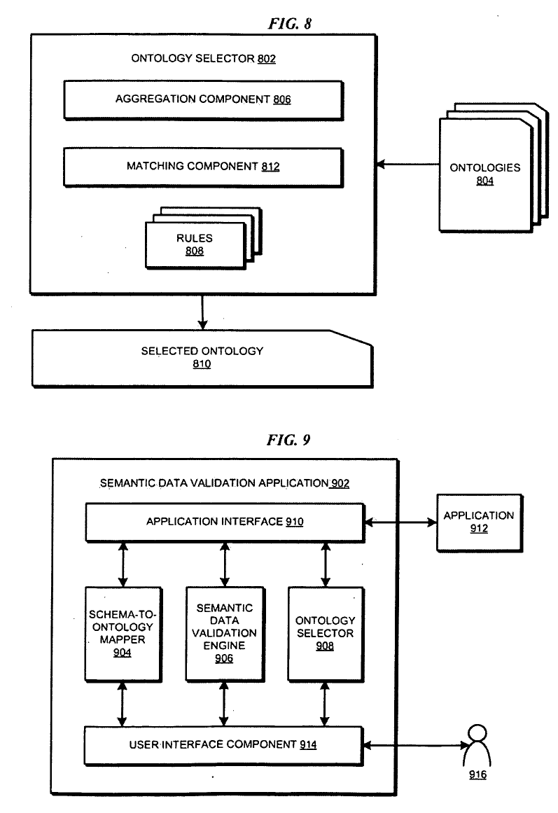

With reference to FIG. 9, this figure depicts a block diagram of some additional components of a semantic data validation application in accordance with an illustrative embodiment. Semantic data validation application 902 may be used as semantic data validation application 602 in FIG. 6. Mapper 902 is analogous to mapper 614, semantic data validation engine 906 is analogous to semantic data validation engine 616, and ontology selector 908 is analogous to ontology selector 610 in FIG. 6 respectively.

Semantic data validation application 902 may additionally include application interface 910. Application 912 may be external to semantic data validation application 902 and may interact with semantic data validation application 902 using application interface 910. For example, application 912 may be a federated data schema generator, and may supply the federated data schema to semantic data validation application 902 using a part of application interface 910. As another example, application 912 may be a rule authoring application and may add, delete, modify, or otherwise manipulate rules included in components of semantic data validation application 902. For example, the rule authoring application may add a new rule in ontology selector 908, or may modify a condition in a rule in semantic data validation engine 906.

The applications described as examples of application 912 are not intended to be limiting on the illustrative embodiments. Application interface 910 can be configured to enable communication with any application as may be suitable for any given implementation. Any application according to a particular implementation may communicate with semantic data validation application 902 using application interface 910.

Semantic data validation application 902 may additionally include user interface component 914. Users, such as user 916, may interact with semantic data validation application 902 using user interface component 914. For example, user 916 may add, remove, modify, or manipulate a rule in semantic data validation application 902 using user interface component 914. As another example, user 916 may manipulate a mapping created by mapper 904 using user interface component 914. User interface component 914 may be configured in any manner suitable for a particular implementation without departing the scope of the invention.

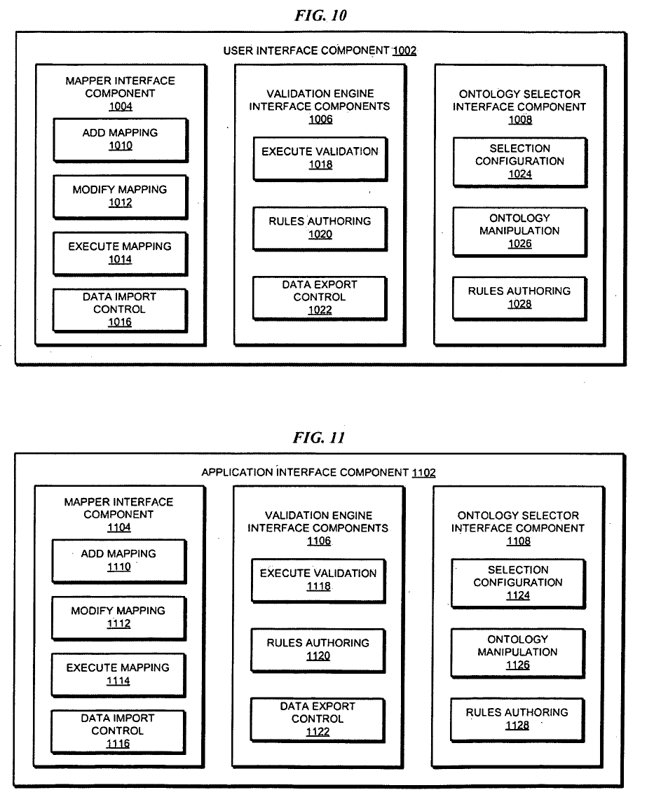

With reference to FIG. 10, this figure depicts a block diagram of some example operations that may be configured to execute using a user interface component of a semantic data validation application in accordance with an illustrative embodiment. User interface component 1002 may be used as user interface component 914 in FIG. 9.

In the example embodiment depicted in this figure, user interface component 1002 may include but is not limited to mapper interface component 1004, validation engine interface component 1006, and ontology selector interface component 1008. Each of components 1004, 1006, and 1008 allow a user to interact with a corresponding component of the semantic data validation application.

As an example, mapper interface component 1004 may include component 1010 to allow a user to add a mapping to a mapper component. Component 1012 may allow a user to modify an existing mapping. Component 1014 may allow a user to execute a mapping.

Component 1016 may allow a user to control what data is imported into the mapper of the semantic data validation application. For example, using component 1016, the user may control which schemas or parts thereof to import given a set of ontologies. Conversely, the user may control which ontologies from which domains to import given a particular schema.

As an example, validation engine interface component 1006 may include component 1018 that may allow a user to execute a semantic validation operation of the semantic data validation application. Component 1020 may allow a user to author a rule, such as create a new rule, modify an existing rule, or delete a rule, used by a semantic data validation engine in the semantic data validation application.

Component 1022 may allow the user to control the form of output from the semantic data validation engine. For example, the user may be able to design a report template using component 1022. As another example, the user may be able to configure how corrected data output is applied to a particular data source. As another example, the user may be able to configure when to make a correction recommendation and when to perform the correction automatically based on the semantic validation of data.

As an example, ontology selector interface component 1008 may include component 1024 that may allow a user to configure how the ontology selector component of the semantic data validation application selects an ontology. For example, using component 1024, the user may be able to configure when the ontology selector aggregates, matches, or aggregates and matches ontologies in order to produce the selected ontology.

Component 1026 may allow a user to manipulate an ontology received from a source, an ontology resulting from aggregation or matching operations in the ontology selector, or another ontology. Component 1028 may allow the user to author rules used by ontology selector component of the semantic data validation application. For example, component 1028 may operate in a manner similar to component 1020.

The components described above are only representative sampling of components that can be included in user interface component 1002 in one embodiment. Additional embodiments of user interface component 1002 may include additional, fewer, or different components within the scope of the invention.

With reference to FIG. 11, this figure depicts a block diagram of some example operations that may be configured to execute using an application interface component of a semantic data validation application in accordance with an illustrative embodiment. Application interface component 1002 may be used as application interface component 910 in FIG. 9.

In the example embodiment depicted in this figure, application interface component 1102 may include but is not limited to similar components as described with respect to user interface component 1002 in FIG. 10. An application can use such similar components to perform operations similar to the operations a user may perform using corresponding components in FIG. 10.

For example, mapper interface component 1104, validation engine interface component 1106, and ontology selector interface component 1108 may each allow an application to perform a similar function as their corresponding components in FIG. 10. As an example, each of components 1104, 1106, 1108 allow an application to interact with a corresponding component of the semantic data validation application.

Component 1110 may allow an application to add a mapping to a mapper component. Component 1112 may allow an application to modify an existing mapping. Component 1114 may allow an application to execute a mapping.

Component 1116 may allow an application to control what data is imported into the mapper of the semantic data validation application. Validation engine interface component 1106 may include component 1118 that may allow an application to execute a semantic validation operation of the semantic data validation application. Component 1120 may allow an application to manipulate a rule, such as create a new rule, modify an existing rule, or delete a rule, used by a semantic data validation engine in the semantic data validation application.

Component 1122 may allow the application to control the form of output from the semantic data validation engine. For example, the application may be able to provide a design for a report template using component 1122. As another example, the application may be able to configure how corrected data output is applied to a particular data source. As another example, the application may be able to configure when to make a correction recommendation and when to perform the correction automatically based on the semantic validation of data.

As an example, ontology selector interface component 1108 may include component 1124 that may allow an application to configure how the ontology selector component of the semantic data validation application selects an ontology. For example, using component 1124, the application may be able to configure when the ontology selector aggregates, matches, or aggregates and matches ontologies in order to produce the selected ontology.

Component 1126 may allow an application to manipulate an ontology received from a source, an ontology resulting from aggregation or matching operations in the ontology selector, or another ontology. Component 1128 may allow the application to manipulate rules used by ontology selector component of the semantic data validation application. For example, component 1128 may operate in a manner similar to component 1120.

The components described above are only representative sampling of components that can be included in application interface component 1102 in one embodiment. Additional embodiments of application interface component 1102 may include additional, fewer, or different components within the scope of the invention.

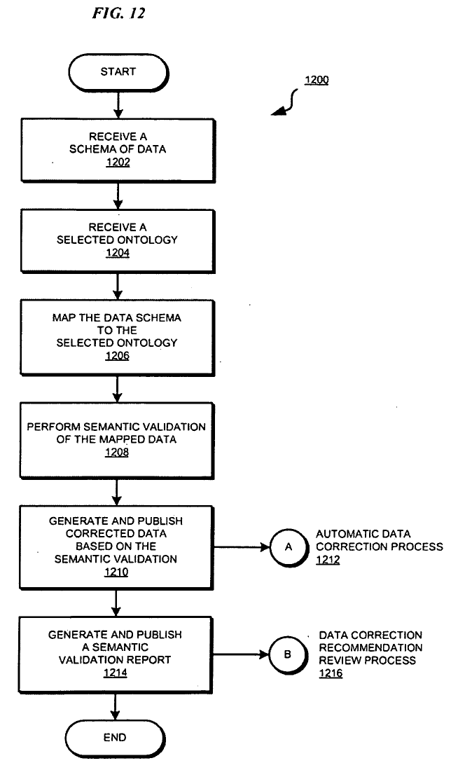

With reference to FIG. 12, this figure depicts a flowchart of a process of performing semantic data validation in accordance with an illustrative embodiment. Process 1200 may be implemented using a semantic data validation application, such as semantic data validation application 902 in FIG. 9.

Process 1200 begins by receiving a schema of data (step 1202). The schema received in step 1202 may be the federated data schema. Process 1200 receives a selected ontology (step 1204).

Process 1200 maps the data schema to the selected ontology (step 1206). Process 1200 performs semantic validation of the mapped data (step 1208). Process 1200 generates and publishes corrected data based on the semantic validation (step 1210). Process 1200 may hand-off the corrected data to an automatic data correction process, labeled “A” (step 1212) such that process “A” can apply the corrected data to the relevant data source. An example of process “A” may be a database update process designed for updating data in a relational database.

In addition to or instead of step 1210, process 1200 may also generate and publish a semantic validation report (step 1214). Process 1200 may hand-off such a report to a data correction recommendation review process labeled “B” (step 1216). An example of process “B” may be a workflow designed to allow one or more applications, users, or a combination thereof, to verify the correction recommendation, and authorize any data modification at a data source. Process 1200 ends thereafter.

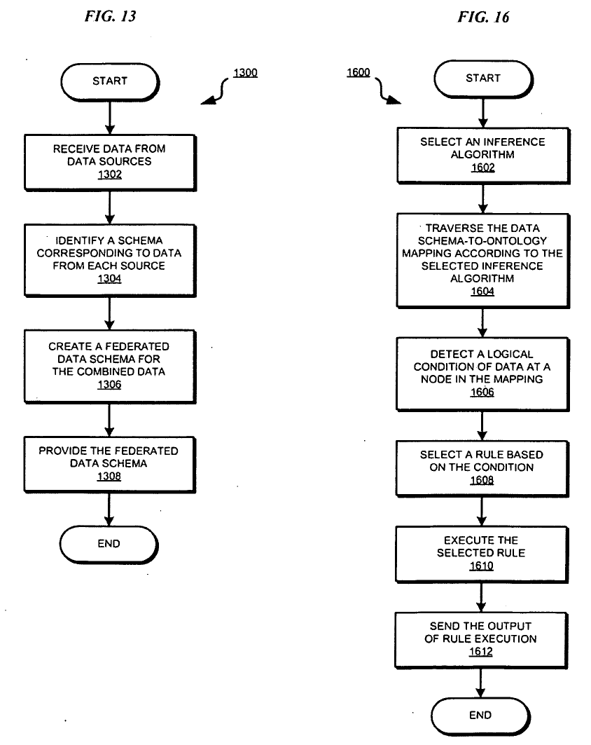

With reference to FIG. 13, this figure depicts a flowchart of a process of providing a federated data schema in accordance with an illustrative embodiment. Process 1300 may be implemented in a federated data schema generator, such as federated data schema generator 608 in FIG. 6.

Process 1300 begins by receiving data from one or more data sources (step 1302). Process 1300 identifies a schema associated with and corresponding to the data from each data source (step 1304). Process 1300 creates a federated data schema for the combined data, such as by applying rules, configurations, and instructions to merging of data from different data sources (step 1306). Process 1300 provides the federated data schema to a semantic data validation application (step 1308). Process 1300 ends thereafter.

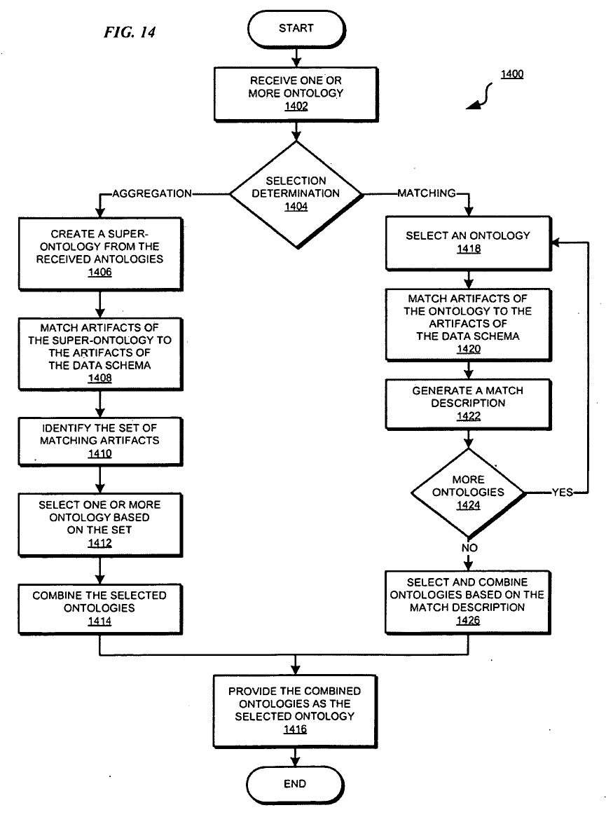

With reference to FIG. 14, this figure depicts a flowchart of a process of selecting an ontology in accordance with an illustrative embodiment. Process 1400 may be implemented using an ontology selector, such as ontology selector component 908 in FIG. 9.

Process 1400 begins by receiving one or more ontologies from ontology sources (step 1402). Process 1400 makes a determination whether aggregation method is to be used or matching method is to be used for selecting an ontology (step 1404). Process 1400 may also determine to use a combination of the two methods (not shown) by using a combination of the steps from each method within the scope of the invention.

If process 1400 determines to use the aggregation method (“Aggregation” path of step 1404), process 1400 creates a super-ontology from the received ontologies (step 1406). A super-ontology is an ontology obtained by combining two or more ontologies according to some logic. Furthermore, step 1406 may combine all or some of the ontologies received in step 1402 to create the super-ontology.

Process 1400 may match artifacts of the super-ontology to the artifacts of the data schema, such as the federated data schema available to the semantic data validation application (step 1408). Process 1400 identifies a set of matching artifacts in the super-ontology (step 1410). The matching of artifacts may utilize various degrees of match and identify an artifact as matching if the degree of match for that artifact meets or exceeds a threshold value.

Process 1400 selects one or more ontology from the ontologies received in step 1402 based on the set identified in step 1410 (step 1412). Process 1400 combines the ontologies selected in step 1412 (step 1414). Process 1400 provides the combined ontology as the selected ontology (step 1416).

In an alternative embodiment (not shown), instead of selecting of step 1412 and combining of step 1414 process 1400 may trim or make unavailable those artifacts from the super-ontology of step 1406 that do not match a corresponding artifact in the schema or at least do not match to a threshold degree. Process 1400 may then provide the remaining trimmed super-ontology as the selected ontology in step 1416. Process 1400 ends thereafter.

Returning to step 1404, if process 1400 determines to use the matching method (“Matching” path of step 1404), process 1400 selects an ontology from the ontologies received in step 1402 (step 1418).

Process 1400 matches the artifacts of the ontology of step 1418 to the artifacts of the data schema (step 1420). Process 1400 generates a match description, such as a Boolean match or a degree of matching (step 1422).

Process 1400 determines if more ontologies remain to be matched (step 1424). If more ontologies remain to be matched (“Yes” path of step 1424), process 1400 returns to step 1418. If no more ontologies remain (“No” path of step 1424), process 1400 selects and combines one or more ontologies based on the match description of step 1422 (step 1426). Process 1400 provides the combined ontology as the selected ontology in step 1416. Process 1400 ends thereafter.

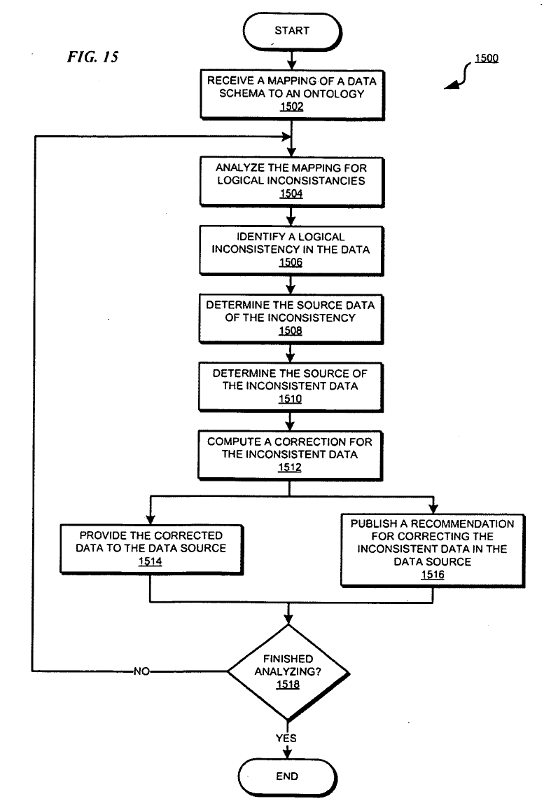

With reference to FIG. 15, this figure depicts a flowchart of a process of semantic data validation in accordance with an illustrative embodiment. Process 1500 can be implemented in a semantic data validation engine, such as semantic data validation engine 906 in FIG. 9.

Process 1500 begins by receiving a mapping of data schema to a selected ontology (step 1502). Process 1500 analyzes the mapping for logical inconsistencies (step 1504).

Process 1500 identifies a logical inconsistency in the data related to the schema (step 1506). Process 1500 determines a source of the data that is the source of the inconsistency (step 1508). Process 1500 determines a source of the data that is inconsistent according to step 1508 (step 1510).

Process 1500 computes a correction for the inconsistent data (step 1512). For example, process 1500 may cause a rules engine to execute a rule that determines how an inconsistent data should be corrected.

Correction of inconsistent data according to process 1500 relies on relationships with the various data sources. For example, one relationship may be based proximity of a data source. Process 1500 may prefer the data from a data source nearer to process 1500 as compared to another data source on a data network. In some data processing environments, the proximity of a data source may be analogous to data sources being inside or outside a network, being federated or non-federated, or within or outside the configuration of a data processing system.

Another example way of preferring one data source to another may be the age of the data source. For example, process 1500 may prefer data from a data source that may have been established longer than another data source in case of semantic inconsistency in their respective data.

As another example, process 1500 may determine which data source to rely upon and which other data source to correct based on other information. For example, reliability of data from one data source may depend on third party information about that data, data source, or both. For example, an independent third party may vouch for a data source, deeming the data source to be reliable. As another example, consistency of other data in a data source may assist process 1500 in determining whether or not to trust a piece of data from that data source when the data conflicts with similar data from another data source.

Another example relationship may be based on trust, to with, whether process 1500 trusts one data source more than another. Consequently, in the event of conflicting or inconsistent data, process 1500 may prefer data from a more trusted source to data from a less trusted source.

An example rule may give more weight to one data source over another based on the trust relationship with the data sources. Rules may be configured to determine how to prefer one data source to another for identifying the correct data and correcting the inconsistent data. Data ownership rule, majority rule, and data trustworthiness rules described in this disclosure are some examples of such rules. Other rules for determining a preferred data source and correcting data for semantic errors will be readily conceivable from this disclosure and the same are contemplated within the scope of the invention. For example, an implementation may employ a combination of the trustworthiness rule and the ownership rule to determine that even if the data is from a foreign source, if that source is trustworthy, then that data can prevail over the data from an owned data source.

Process 1500 may publish the corrected data to the appropriate data source (step 1514). Alternatively, or in conjunction with step 1514, process 1500 may also publish a recommendation for correcting the inconsistent data in the data source (step 1516).

Process 1500 may determine if the analysis of the entire mapping is complete (step 1518). If the analysis is not complete (“No” path of step 1518), process 1500 returns to step 1504. If the analysis is complete (“Yes” path of step 1518), process 1500 ends.

With reference to FIG. 16, this figure depicts a flowchart of a process of detecting a semantic error in accordance with an illustrative embodiment. Process 1600 may be implemented in a semantic data validation engine, such as semantic data validation engine 906 in FIG. 9.

Process 1600 begins by selecting an inference algorithm (step 1602). Process 1600 traverses the schema-to-ontology mapping according to the selected inference algorithm (step 1604).

Process 1600 detects a logical condition, such as a logical error or a logical inconsistency, at a node in the mapping (step 1606). Process 1600 selects a rule based on the condition (step 1608). For example, a rule may inform process 1600 how to correct a logical error, such as, for example, a person cannot be a minor and a senior citizen at the same time. For example, the rule may call for selecting and eliminating one age description from the person's data based on some criteria.

As another example, a rule may inform process 1600 how to correct a logical inconsistency, such as the work experience of an employee cannot be greater than the employee's age. The example rule may call for remedying one value based on some criteria so that the age and experience become consistent with one another. Many other rules are conceivable and may be used in a similar manner in step 1608 within the scope of the invention. Furthermore, more than one rule may be selected for execution in step 1608.

Process 1600 executes the selected rule (step 1610). If more than one rule is selected in step 1608, all or a subset of those selected rules may be executed in step 1610. Process 1600 sends the output of rule execution (step 1612). Process 1600 ends thereafter. Sending the output as in step 1612 may send corrected data to a data source, send information to a report, send information to an application, or a combination thereof.

The components in the block diagrams and the steps in the flowcharts described above are described only as examples. The components and the steps have been selected for the clarity of the description and are not limiting on the illustrative embodiments of the invention. For example, a particular implementation may combine, omit, further subdivide, modify, augment, reduce, or implement alternatively, any of the components or steps without departing from the scope of the illustrative embodiments. Furthermore, the steps of the processes described above may be performed in a different order within the scope of the invention.

Thus, a computer implemented method, apparatus, and computer program product are provided in the illustrative embodiments for semantic data validation of disjoint data. Using the embodiments of the invention, semantic validation can be performed so that logical errors and logical inconsistencies in data can be detected and remedied in a manner not achievable with present tools and techniques.

The invention can take the form of an entirely software embodiment, or an embodiment containing both hardware and software elements. In a preferred embodiment, the invention is implemented in software or program code, which includes but is not limited to firmware, resident software, and microcode.

Furthermore, the invention can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W) and DVD.

Further, a computer storage medium may contain or store a computer-readable program code such that when the computer-readable program code is executed on a computer, the execution of this computer-readable program code causes the computer to transmit another computer-readable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage media, and cache memories, which provide temporary storage of at least some program code in order to reduce the number of times code must be retrieved from bulk storage media during execution.

A data processing system may act as a server data processing system or a client data processing system. Server and client data processing systems may include data storage media that are computer usable, such as being computer readable. A data storage medium associated with a server data processing system may contain computer usable code. A client data processing system may download that computer usable code, such as for storing on a data storage medium associated with the client data processing system, or for using in the client data processing system. The server data processing system may similarly upload computer usable code from the client data processing system. The computer usable code resulting from a computer usable program product embodiment of the illustrative embodiments may be uploaded or downloaded using server and client data processing systems in this manner.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to explain the principles of the invention, the practical application, and to enable others of ordinary skill in the art to understand the invention for various embodiments with various modifications as are suited to the particular use contemplated.

What is claimed is:

1. A computer implemented method for semantic data validation of disjoint data stored in a computer memory, the computer implemented method comprising:
selecting an ontology stored in an ontology source in a computer memory;
performing a mapping a first plurality of artifacts from a schema representing the stored disjoint data to a second plurality of artifacts in the ontology and creating a mapping graph having a plurality of nodes, the first plurality of artifacts forming schema artifacts and the second plurality of artifacts forming ontology artifacts, and a node in the plurality of nodes representing the correspondence of a schema artifact to an ontology artifact;
analyzing by executing an inference algorithm in a processor a first node in the plurality of nodes, wherein the analyzing determines a semantic error in a data corresponding to the schema artifact represented at a second node; and
providing to one of (i) a data storage unit of a data processing system and (ii) a display unit of a data processing system, a correction for the data such that the correction eliminates the semantic error.

2. The computer implemented method of claim 1, wherein the schema is a federated data schema generated by combining a plurality of schemas associated with a set of disjoint data from a plurality of data sources, wherein the analyzing further comprises:
validating data represented at the second node in reference to data represented at a third node, the validating causing executing a rule from a plurality of rules;
determining from the validating that the semantic error exists between the data represented at the second node in reference to data represented at a third node; and
concluding that the data represented at the second node is to be corrected, wherein the concluding further comprises executing a second rule from the plurality of rules, the output of executing the second rule causing the conclusion.

3. The computer implemented method of claim 2, wherein the second rule is a data ownership rule.

4. The computer implemented method of claim 2, wherein the second rule is a majority rule.

5. The computer implemented method of claim 2, wherein the second rule is a trustworthiness rule.

6. The computer implemented method of claim 1, wherein selecting the ontology further comprises:
receiving a set of ontologies from at least one ontology source;
aggregating a subset of ontologies from the set of ontologies to form a super-ontology;
matching a set of schema artifacts to a set of artifacts of the super-ontology;
reducing the super-ontology to form a reduced ontology by making unavailable a subset of artifacts from the set of artifacts of the super-ontology such that an artifact in the subset of artifacts one of (i) does not have a corresponding artifact in the schema artifacts, and (ii) matches with a corresponding artifact in the schema artifacts below a threshold degree of match; and
presenting the reduced ontology as the ontology.

7. The computer implemented method of claim 6, wherein the making unavailable a subset of artifacts leaves a second subset of artifacts available for use in the super-ontology, and wherein reducing the super-ontology further comprises:
selecting a subset of ontologies from the set of ontologies such that ontologies in subset of ontologies together include all members of the second subset of artifacts of the super-ontology; and
combining the ontologies in the subset of ontologies to form a combined ontology, the combined ontology becoming the reduced ontology.

8. The computer implemented method of claim 1, wherein selecting the ontology further comprises:
receiving a set of ontologies from at least one ontology source;
choosing a first ontology from the set of ontologies;
performing a first matching a set of schema artifacts to a set of artifacts of the first ontology;
generating a first match description describing a characteristic of match from the first matching;
choosing a second ontology from the set of ontologies;
performing a second matching the set of schema artifacts to a set of artifacts of the second ontology;
generating a second match description describing a characteristic of match from the second matching; and
performing a second selecting from the first and the second ontology using the first and second match descriptions, the second selecting yielding the ontology.

9. The computer implemented method of claim 8, wherein the first and second match descriptions are each a degree of match, the second selecting further comprising:
combining the first and the second ontologies, the combining yielding a combined ontology; and
presenting the combined ontology as the ontology.

10. The computer implemented method of claim 1, wherein the performing the mapping includes:
using a forward inference from a schema artifact in the schema artifacts to map the schema artifact to an ontology artifact in the ontology artifacts, wherein the forward inference is an operation of a second inference algorithm, and wherein the second inference algorithm is one of (i) same as the inference algorithm, and (ii) different from the inference algorithm.

11. The computer implemented method of claim 1, wherein the providing the correction further comprises one of (i) applying the correction to the data represented at the second node by correcting the data at a source of the data, and (ii) publishing a report, the report including a recommendation for correcting the data represented at the second node.

12. The computer implemented method of claim 11, wherein the providing the correction further includes one of (i) detecting a condition in a data processing environment, (ii) causing an action in the data processing environment, and (iii) determining a value of a second data.

13. A computer usable program product comprising a computer usable storage medium including computer usable code for semantic data validation of disjoint data stored in a computer memory, the computer usable code comprising:
computer usable code for selecting an ontology stored in an ontology source in a computer memory;
computer usable code for performing a mapping a first plurality of artifacts from a schema representing the stored disjoint data to a second plurality of artifacts in the ontology and creating a mapping graph having a plurality of nodes, the first plurality of artifacts forming schema artifacts and the second plurality of artifacts forming ontology artifacts, and a node in the plurality of nodes representing the correspondence of a schema artifact to an ontology artifact;
computer usable code for analyzing by executing an inference algorithm in a processor a first node in the plurality of nodes, wherein the analyzing determines a semantic error in a data corresponding to the schema artifact represented at a second node; and
computer usable code for providing to one of (i) a data storage unit of a data processing system and (ii) a display unit of a data processing system, a correction for the data such that the correction eliminates the semantic error.

14. The computer usable program product of claim 13, wherein the schema is a federated data schema generated by combining a plurality of schemas associated with a set of disjoint data from a plurality of data sources, wherein the computer usable code for analyzing further comprises:
computer usable code for validating data represented at the second node in reference to data represented at a third node, the validating causing executing a rule from a plurality of rules;
computer usable code for determining from the validating that the semantic error exists between the data represented at the second node in reference to data represented at a third node; and
computer usable code for concluding that the data represented at the second node is to be corrected, wherein the concluding further comprises executing a second rule from the plurality of rules, the output of executing the second rule causing the conclusion.

15. The computer usable program product of claim 14, wherein the second rule is a data ownership rule.

16. The computer usable program product of claim 14, wherein the second rule is a majority rule.

17. The computer usable program product of claim 14, wherein the second rule is a trustworthiness rule.

18. The computer usable program product of claim 13, wherein the computer usable code for selecting the ontology further comprises:
computer usable code for receiving a set of ontologies from at least one ontology source;
computer usable code for aggregating a subset of ontologies from the set of ontologies to form a super-ontology;
computer usable code for matching a set of schema artifacts to a set of artifacts of the super-ontology;
computer usable code for reducing the super-ontology to form a reduced ontology by making unavailable a subset of artifacts from the set of artifacts of the super-ontology such that an artifact in the subset of artifacts one of (i) does not have a corresponding artifact in the schema artifacts, and (ii) matches with a corresponding artifact in the schema artifacts below a threshold degree of match; and
computer usable code for presenting the reduced ontology as the ontology.

19. The computer usable program product of claim 18, wherein the making unavailable a subset of artifacts leaves a second subset of artifacts available for use in the super-ontology, and wherein the computer usable code for reducing the super-ontology further comprises:
computer usable code for selecting a subset of ontologies from the set of ontologies such that ontologies in subset of ontologies together include all members of the second subset of artifacts of the super-ontology; and
computer usable code for combining the ontologies in the subset of ontologies to form a combined ontology, the combined ontology becoming the reduced ontology.

20. The computer usable program product of claim 13, wherein the computer usable code for selecting the ontology further comprises:
computer usable code for receiving a set of ontologies from at least one ontology source;
computer usable code for choosing a first ontology from the set of ontologies;
computer usable code for performing a first matching a set of schema artifacts to a set of artifacts of the first ontology;
computer usable code for generating a first match description describing a characteristic of match from the first matching;
computer usable code for choosing a second ontology from the set of ontologies;
computer usable code for performing a second matching the set of schema artifacts to a set of artifacts of the second ontology;
computer usable code for generating a second match description describing a characteristic of match from the second matching; and
computer usable code for performing a second selecting from the first and the second ontology using the first and second match descriptions, the second selecting yielding the ontology.

21. The computer usable program product of claim 20, wherein the first and second match descriptions are each a degree of match, the computer usable code for second selecting further comprising:
computer usable code for combining the first and the second ontologies, the combining yielding a combined ontology; and
computer usable code for presenting the combined ontology as the ontology.

22. The computer usable program product of claim 13, wherein the computer usable code for performing the mapping includes:
computer usable code for using a forward inference from a schema artifact in the schema artifacts to map the schema artifact to an ontology artifact in the ontology artifacts, wherein the forward inference is an operation of a second inference algorithm, and wherein the second inference algorithm is one of (i) same as the inference algorithm, and (ii) different from the inference algorithm.

23. The computer usable program product of claim 13, wherein the computer usable code for providing the correction further comprises one of (i) computer usable code for applying the correction to the data represented at the second node by correcting the data at a source of the data, and (ii) computer usable code for publishing a report, the report including a recommendation for correcting the data represented at the second node.

24. The computer usable program product of claim 23, wherein the computer usable code for providing the correction further includes one of (i) computer usable code for detecting a condition in a data processing environment, (ii) computer usable code for causing an action in the data processing environment, and (iii) computer usable code for determining a value of a second data.

25. The computer program product of claim 13, wherein the computer usable code is stored in a computer readable storage medium in a data processing system, and wherein the computer usable code is transferred over a network from a remote data processing system.

26. The computer program product of claim 13, wherein the computer usable code is stored in a computer readable storage medium in a server data processing system, and wherein the computer usable code is downloaded over a network to a remote data processing system for use in a computer readable storage medium associated with the remote data processing system.

27. A data processing system for semantic data validation of disjoint data, the data processing system comprising:
a storage device including a storage medium, wherein the storage device stores computer usable program code; and
a processor, wherein the processor executes the computer usable program code, and wherein the computer usable program code comprises:
computer usable code for selecting an ontology stored in an ontology source in a computer memory;
computer usable code for performing a mapping a first plurality of artifacts from a schema representing the stored disjoint data to a second plurality of artifacts in the ontology and creating a mapping graph having a plurality of nodes, the first plurality of artifacts forming schema artifacts and the second plurality of artifacts forming ontology artifacts, and a node in the plurality of nodes representing the correspondence of a schema artifact to an ontology artifact;
computer usable code for analyzing by executing an inference algorithm in a processor a first node in the plurality of nodes, wherein the analyzing determines a semantic error in a data corresponding to the schema artifact represented at a second node; and
computer usable code for providing to one of (i) a data storage unit of a data processing system and (ii) a display unit of a data processing system, a correction for the data such that the correction eliminates the semantic error.

28. The data processing system of claim 27, wherein the schema is a federated data schema generated by combining a plurality of schemas associated with a set of disjoint data from a plurality of data sources, wherein the computer usable code for analyzing further comprises:
computer usable code for validating data represented at the second node in reference to data represented at a third node, the validating causing executing a rule from a plurality of rules;
computer usable code for determining from the validating that the semantic error exists between the data represented at the second node in reference to data represented at a third node; and
computer usable code for concluding that the data represented at the second node is to be corrected, wherein the concluding further comprises executing a second rule from the plurality of rules, the output of executing the second rule causing the conclusion.

29. The data processing system of claim 28, wherein the second rule is a data ownership rule.

30. The data processing system of claim 28, wherein the second rule is a majority rule.

31. The data processing system of claim 28, wherein the second rule is a trustworthiness rule.

32. The data processing system of claim 27, wherein the computer usable code for selecting the ontology further comprises:
computer usable code for receiving a set of ontologies from at least one ontology source;
computer usable code for aggregating a subset of ontologies from the set of ontologies to form a super-ontology;
computer usable code for matching a set of schema artifacts to a set of artifacts of the super-ontology;
computer usable code for reducing the super-ontology to form a reduced ontology by making unavailable a subset of artifacts from the set of artifacts of the super-ontology such that an artifact in the subset of artifacts one of (i) does not have a corresponding artifact in the schema artifacts, and (ii) matches with a corresponding artifact in the schema artifacts below a threshold degree of match; and
computer usable code for presenting the reduced ontology as the ontology.

33. The data processing system of claim 27, wherein the computer usable code for selecting the ontology further comprises:
computer usable code for receiving a set of ontologies from at least one ontology source;
computer usable code for choosing a first ontology from the set of ontologies;
computer usable code for performing a first matching a set of schema artifacts to a set of artifacts of the first ontology;
computer usable code for generating a first match description describing a characteristic of match from the first matching;
computer usable code for choosing a second ontology from the set of ontologies;
computer usable code for performing a second matching the set of schema artifacts to a set of artifacts of the second ontology;
computer usable code for generating a second match description describing a characteristic of match from the second matching; and
computer usable code for performing a second selecting from the first and the second ontology using the first and second match descriptions, the second selecting yielding the ontology.

34. The data processing system of claim 27, wherein the computer usable code for performing the mapping includes:
computer usable code for using a forward inference from a schema artifact in the schema artifacts to map the schema artifact to an ontology artifact in the ontology artifacts, wherein the forward inference is an operation of a second inference algorithm, and wherein the second inference algorithm is one of (i) same as the inference algorithm, and (ii) different from the inference algorithm.

35. The data processing system of claim 27, wherein the computer usable code for providing the correction further comprises:
computer usable code for one of (i) applying the correction to the data represented at the second node by correcting the data at a source of the data, and (ii) publishing a report, the report including a recommendation for correcting the data represented at the second node; and
computer usable code for one of (i) detecting a condition in a data processing environment, (ii) causing an action in the data processing environment, and (iii) determining a value of a second data.
